(19) United States
(12) Patent Application Publication
(10) Pub. No.: US 2022/0343069 A1
(43) Pub. Date: Oct. 27, 2022

(54) METHOD OF CONVERTING BETWEEN AN N-TUPLE AND A DOCUMENT USING A READABLE TEXT AND A TEXT GRAMMAR

(71) Applicant: JONATHAN MARK VYSE, LONDON (GB)

(72) Inventor: JONATHAN MARK VYSE, LONDON (GB)

(21) Appl. No.: 17/239,553

(22) Filed: Apr. 24, 2021

(51) Int. Cl. G06F 40/232; G06F 40/226; G06F 40/166

(52) U.S. Cl. CPC G06F 40/232; G06F 40/226; G06F 40/166

(57) ABSTRACT

Embodiments are directed at processing language content by a method of bi-directional conversion between language content with additional information to and from documents, using a readable text and a text grammar. A method combines additional information with the language content using punctuation idioms. The combined language content and additional information remains readable by one ordinarily skilled in the art of reading and also remains allowable according to a text grammar; that is embodiments are rigorous and may be declarative. The document is compliant with a format drawn from a set which comprises SGML, XML, TEI, HTML, DOC, DOCX, ODX, PDF and XPS. The document is publishable in a medium drawn from a set which comprises a book, a magazine, a journal, a newspaper, an article and a web page. A computer-readable memory device and a computing device are also claimed.

A method of converting between an n-tuple and a document using a readable text and a text grammar.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMIT-TED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### (1) Field of the Invention

### BACKGROUND OF THE INVENTION

This invention relates to the method of converting between language and documents.

### (2) Description of the Related Art

### Definitions

(computer grammar) ‘a set of rules governing what strings are valid or allowable in a language or text’ (Oxford)
(control characters) characters which are typically not displayed but are interpreted as a control functions ‘defined by their effects on a character-imaging input/output device’ (ECMA 48)
(allowable text) a text which is allowable according to a text grammar and which may or may not have been demonstrated to be so allowable by verification
(grammar) a whole system and structure of a language
(plain text) a text containing mostly letters, digits, punctuation and so on, and only a very small set of control characters typically limited to line and paragraph formatting
(text) a text which may or may not be an allowable text or may or may not be a plain text

### Definitions, Acronyms and Abbreviations

(ISO) International Organization for Standardization
(HTML) HyperText Markup Language
(SGML) Standard Generalized Markup Language
(TEI) Text Encoding Initiative
(XML) eXtensible Markup Language

Languages may be written. A process and a set of character marks are used to create text. When stored as data on a computer with all but a few marks plainly visible to the reader and each visible mark having a plain meaning, the text is termed a plain text.

Not all of the very large combinations of marks represent valid or allowable texts. The process of writing text is constrained by a complicated test of validity contained in the language grammar and rules for writing the language.

Many further aspects of text, for example line length, are a matter of choice or style and can be varied without changing the meaning of the text. The specification of such variations is not part of the text itself.

The text may also include information about itself, such as the name of the author, and such information may only be distinguishable from other parts of the text by conventions, such as position within the text. Such conventions are also matters of choice or style.

Recently, systems for processing text have become common. In such systems the structure containing the tests of validity of the text is known as a computer grammar. A text which conforms to the structure of the computer grammar is considered a valid or an allowable text.

The current art of text processing is to process not the original text but a more complex adulterated version of the text; a version created by intertwining the original text with auxiliary foreign marks drawn from a so called markup language. These foreign marks specify some further aspects of the text. This poses the classic question of definition—‘what is the text?’ Is the text the original text or the adultorated text?

The implicit assumption of the current art of text processing is that the original text is not rich enough in information for some purposes; the original text requires augmenting and this augmentation should consist of auxiliary foreign marks drawn from a so called markup language.

These foreign marks also conform to a computer grammar. The text itself may conform to both a language grammar and to another computer grammar. The adulterated text may therefore be required to conform to two computer grammars and a language grammar.

These foreign marks are termed ‘visible markup’ because they consist of marks somewhat familiar in plain text. Computer processing techniques are used to ensure the foreign marks are not confused with the original text. These foreign marks are not presented to the reader with the original text for reading; they make the text unreadable, or at least less readable. Rather, these foreign marks are hidden by the viewing tools, viewing tools rendered necessary by the complexity introduced by the process of adulteration.

The Standard Generalized Markup Language (SGML), standardised by the International Organization for Standardization (ISO) in their document number 8879 of 1986, is for specifying markup languages ‘for document representation’ and ‘can be used for publishing in its broadest definition’. The standard states that ‘[g]eneralised markup is based on two novel postulates’, that it is (a) declarative, and (b) rigorous. The standard provides an example of an actual markup language in its ‘reference concrete syntax’, an example which has been very widely adopted. The standard states of itself that ‘to be an acceptable standard’ it must recognise constraints, including ‘accomodat[ing] familiar typewriter text entry conventions. The standard states that the “short reference” and “data tag” capabilities [of SGML] support typewriter text entry conventions. Normal text containing paragraphs and quotations is interpretable as SGML although it is keyable with no visible markup.’ Typewriter text entry conventions are therefore viewed as easing text entry.

HyperText Markup Language (HTML), standardised by ISO in their document number ISO/IEC 15445 of 2000, is an ‘application’ of SGML. Other versions of HTML are not conforming SGML; both earlier and later versions. HTML from the early 1990s onwards is ‘strongly based on SGML’ and the HTML version from 2017 is ‘a custom format inspired by SGML’. ‘Originally, HTML was primarily designed as a language for semantically describing scientific documents.’ The SGML declaration of ISO/IEC 15445 sets the ‘MINIMIZE’ feature ‘DATATAG’ to ‘NO’ and the ‘SYNTAX’ for ‘SHORTREF’ to ‘SGMLREF’, thereby removing support for ‘no visible markup’ and requiring ‘visible markup’.

‘Extensible Markup Language (XML) is a simple, very flexible text format derived from SGML (ISO 8879).’ It emerged from proposals to simplify SGML, ‘specifically, keeping all the structural flexibility but losing many syntax options,’ and as ‘a “subset” of SGML designed for Web use.’ The SGML subset declaration for XML from 1997 sets the ‘MINIMIZE’ feature ‘DATATAG’ to ‘NO’ and the ‘SYNTAX’ for ‘SHORTREF’ to ‘NONE’, thereby removing support for ‘no visible markup’ and requiring ‘visible markup’. Although ‘a text format’, XML is often used in information domains other than documents.

HTML and XML specifications both require ‘visible markup’ having removed features and syntax from SGML providing support for ‘typewriter text conventions’ or ‘no visible markup’.

The problems with ‘visible markup’, that is adulterating a text by intertwining the original text with foreign marks, are manifold and include:
(a) the problem of veracity, that is the text actually processed is very different from the original text, leading to doubts as to its veracity and the question ‘what is the text?’;
(b) the problem of intellectual ownership, that is who owns the specification for the foreign marks, who invented them, who applied them to a particular text, who owns the combined work;
(c) the problem of complexity, that is who bears the cost of learning, implementing and maintaining these new foreign marks and associated tools;
(d) the problem of longevity, that is will the scheme for using foreign marks endure or will its marks become obsolete before the actual text they are intertwined with, so rendering the text actual unintelligible;
(e) the problem of subjectivity, that is what do the foreign marks mean?;
(f) the problem of clarity, that is how to read the foreign marks and how to understand the boundaries, particularly around whitespace, leading to the problematic requirement to use tools just to read the adultorated text; and
(h) the problem of generality, that is the loss of benefits gained from specialising in the very ancient and important cultural domain of text—perhaps mankind's greatest invention.

The foreign marks may be stored ‘standing-off’ from the original text and be intertwined only indirectly using a pointing scheme. This solves some of these problems, however, it introduces the additional problem of alignment, that is of maintaining the pointing references when the original text is modified in even a trivial way, such as introducing an additional blank line or changing line length.

Use of SGML, with its support for ‘no visible markup’, is reducing. ‘([A]s of July 2002), “relatively few enterprise-level projects are started as SGML applications”’. The Text Encoding Initiative (TEI), for example, states: ‘[t]he encoding scheme defined by these [P5 2007] Guidelines is formulated as an application of the Extensible Markup Language (XML)’ following ‘the release of P4 in 2002, when the TEI changed its underlying representation from SGML to XML.’

HTML and XML markup languages both require ‘visible markup’ and are more widely used than SGML with its support for ‘no visible markup’.

Text is a very ancient and important cultural domain, perhaps mankind's greatest invention. The implicit assumption of the current art of text processing is that the original text is not rich enough in information for some purposes. Are we sure that is correct?

In summary, how is one ordinarily skilled in reading texts to avoid using texts obfuscated by the process of adulteration with ‘visible markup’ and yet benefit from computer text processing?

An improvement in text processing is required.

### BRIEF SUMMARY OF THE INVENTION

This summary is not an aid in determining claim scope but merely introduces some simplified concepts and some features from the Detailed Description.

Embodiments are directed at processing language content by a method of bi-directional conversion between language content with additional information to and from documents, using a readable text and a text grammar.

According to embodiments, a method combines additional information with the language content using punctuation idioms.

According to embodiments, the combined language content and additional information remains readable by one ordinarily skilled in the art of reading and also remains allowable according to a text grammar; that is embodiments are rigorous and may be declarative.

According to some embodiments, the document is compliant with a format drawn from a set which comprises SGML, XML, TEI, HTML, DOC, DOCX, ODX, PDF and XPS.

According to some embodiments, the document is publishable in a medium draw from a set which comprises a book, a magazine, a journal, a newspaper, an article and a web page.

According to some embodiments, a method enables the readable text to comprise a limited character repertoire.

According to some embodiments, a method uses a context free computer grammar for the text grammar and implements the method using tools known as lex and yacc.

According to some embodiments, a method encodes, in the symbols of the first text grammar, some symbol names drawn from a second text grammar, so enabling a conversion between formats as a mere side-effect of parsing, with no additional actions, that is a declarative conversion.

Next, some embodiments store instructions for a converting method on a computer readable memory device.

Next, some embodiments use a computing device with stored instructions on a computer readable memory device for a converting method.

The following detailed description and the drawings will make these and other features apparent. Neither they nor this summary restrict aspects as claimed.

### BRIEF DESCRIPTION OF THE SEVERAL VIEWS OF THE DRAWING(S)

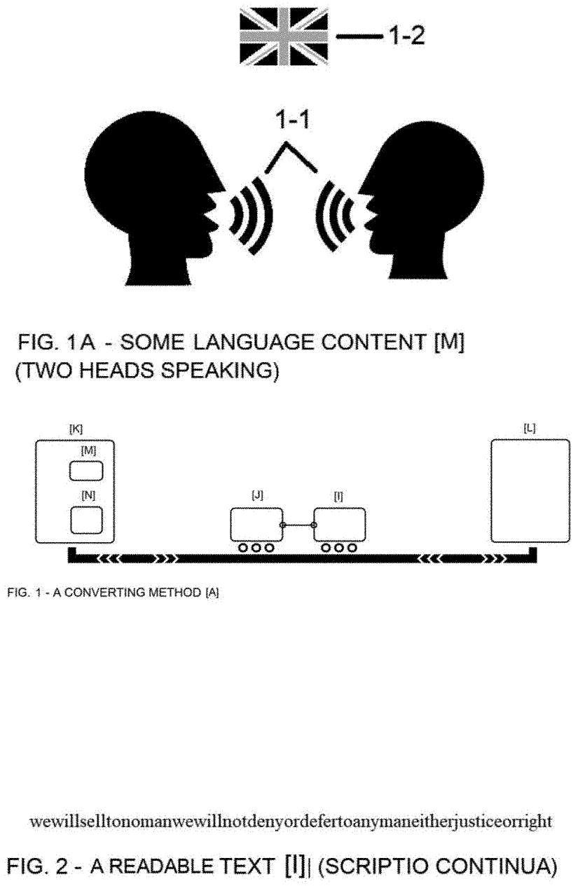

Figures are labelled ‘FIG.’ followed by a space then a number, for example ‘FIG. 1’. Additionally, capital letters may be appended to the number if required by later insertion of further figures, for example ‘FIG. 1A’. Additional capital letters do not represent parts of a whole figure, part A, B, C and so on, merely later insertions of figures.

In figures, elements of claims and their sub-elements may be labelled with so called reference signs. Reference signs are one or more capital letters in square brackets, for example ‘[A]’ or ‘[BA]’. These reference signs are also used as labels in the running text.

Reference signs do not limit the claims; when used, their sole function is to make claims and running text easier to understand.

In figures, elements of claims and their sub-elements may also be labelled with so called figure labels. Figure labels consist of the number of the figure, followed by a hyphen, followed by two unique consecutive numbers, again all in square brackets, for example ‘[1-02].’.

Each element of the claims may be labelled with a unique reference sign, if more than one element of the same type occurs in the claims it will have a different reference sign and a different name, for example ‘a first foo element [A]’ and ‘a second foo element [B]’. Some elements of some claims appear in multiple figures, for example those that show embodiments or example inputs and outputs of methods and sub-methods. Such elements will have the same reference sign but multiple, varied figure labels.

### BRIEF DESCRIPTION OF THE SEVERAL VIEWS OF THE DRAWING(S)

Some figure labels may be omitted if referenced in the figure caption or otherwise obvious, or not referenced from the running text; when omitted the sole reason is to reduce clutter and make figures easier to understand.

The figures are typical of computer and method patent applications, with components and steps represented in a ‘block diagram’ format, functionally labelled, and interconnected by lines or arrows. The figures do not represent views of mechanical objects.

In the figures, elements, sub-elements, embodiments, methods and sub-methods are shown as rectangles, final inputs and outputs are shown as rectangles with rounded corners, and intermediate inputs and outputs are similarly shown as rectangles with rounded corners. The figures do not conform to any external diagramming standard or notation.

### LIST OF DRAWINGS

FIG. 1—A CONVERTING METHOD [1];

FIG. 1A—SOME LANGUAGE CONTENT [M] (TWO HEADS SPEAKING);

FIG. 2—A READABLE TEXT [I] (SCRIPTIO CONTINUA);

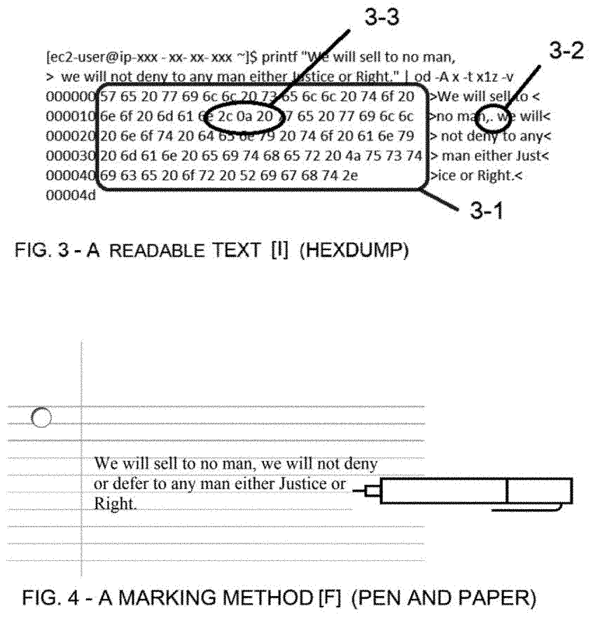

FIG. 3—A READABLE TEXT [I] (HEXDUMP):

FIG. 4—A MARKING METHOD [F] (PEN AND PAPER);

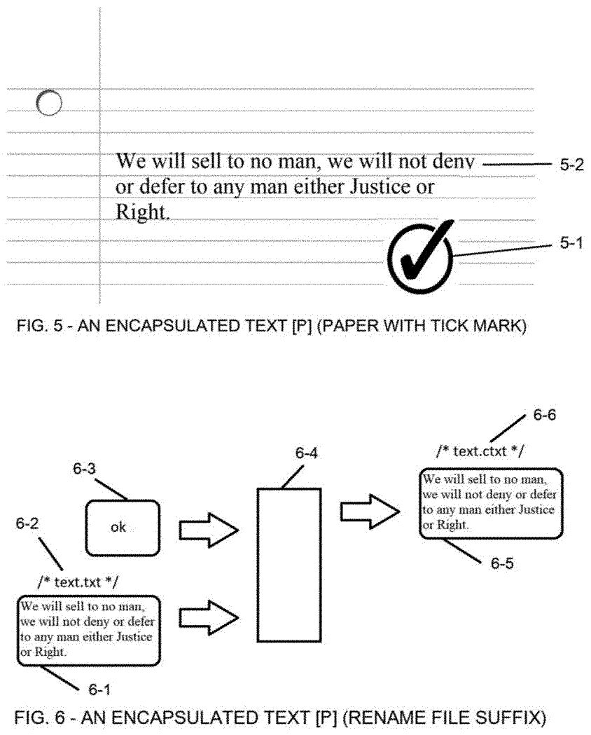

FIG. 5—AN ENCAPSULATED TEXT [P] (PAPER WITH TICK BOX);

FIG. 6—AN ENCAPSULATED TEXT [P] (RENAMED FILE SUFFIX);

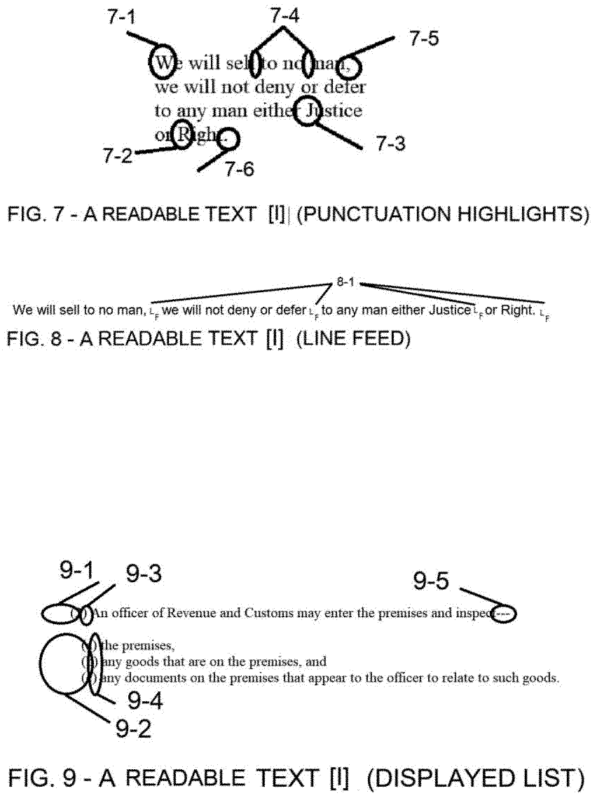

FIG. 7—A READABLE TEXT [I] (PUNCTUATION HIGHLIGHTS);

FIG. 8—A READABLE TEXT [I] (PUNCTUATION HIGHLIGHTS—LINE FEED);

FIG. 9—A READABLE TEXT [I] (DISPLAYED LIST);

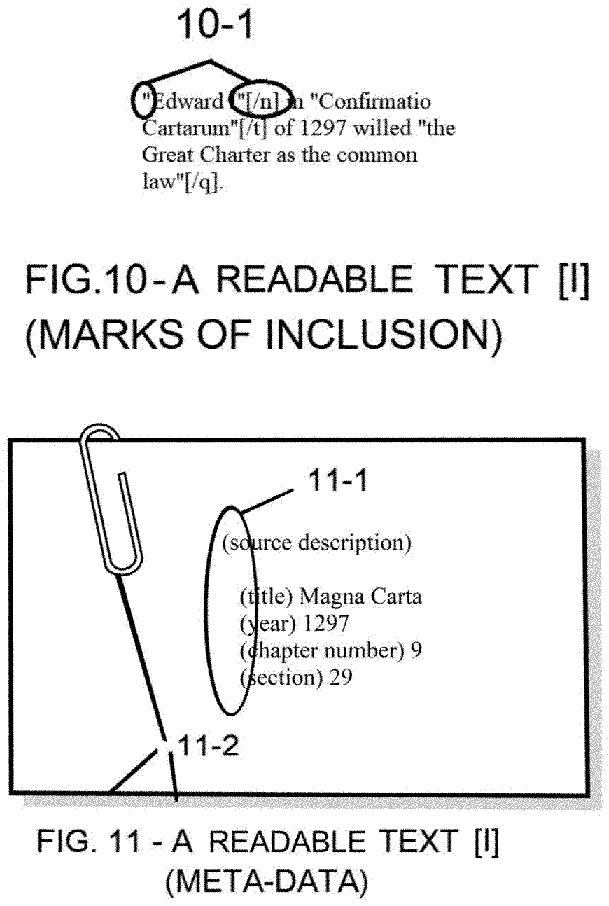

FIG. 10—A READABLE TEXT [I] (MARKS OF INCLUSION);

FIG. 11—A READABLE TEXT [I] (META-DATA);

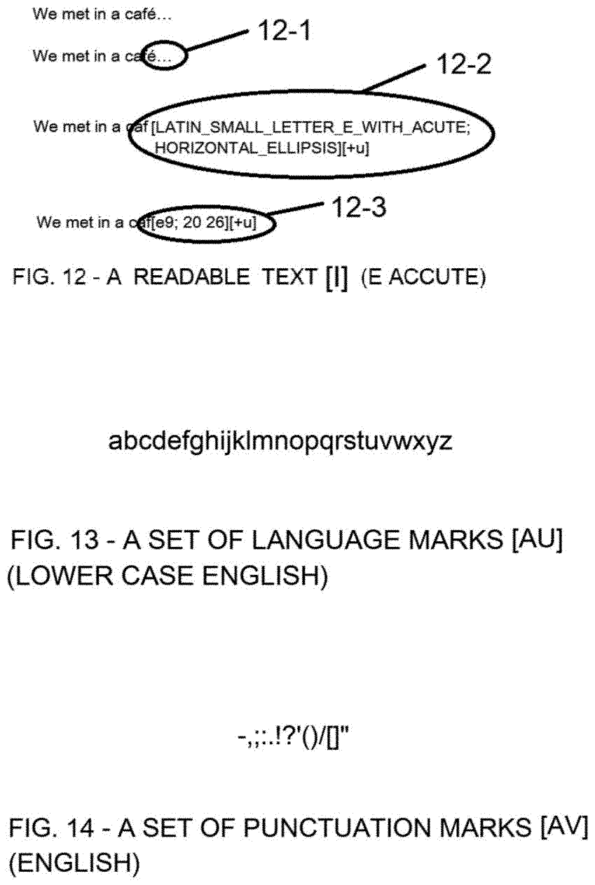

FIG. 12—A READABLE TEXT [I] (E ACUTE):

FIG. 13—A SET OF LANGUAGE MARKS [AU] (LOWER CASE ENGLISH);

FIG. 14—A SET OF PUNCTUATION MARKS [AV] (ENGLISH);

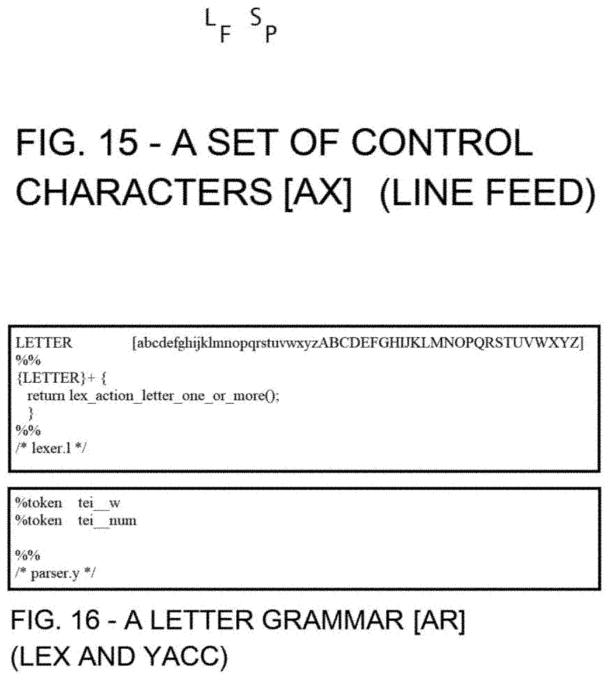

FIG. 15—A SET OF CONTROL CHARACTERS [AX] (LINE FEED)

FIG. 16—A LETTER GRAMMAR [AR] (LEX AND YACC);

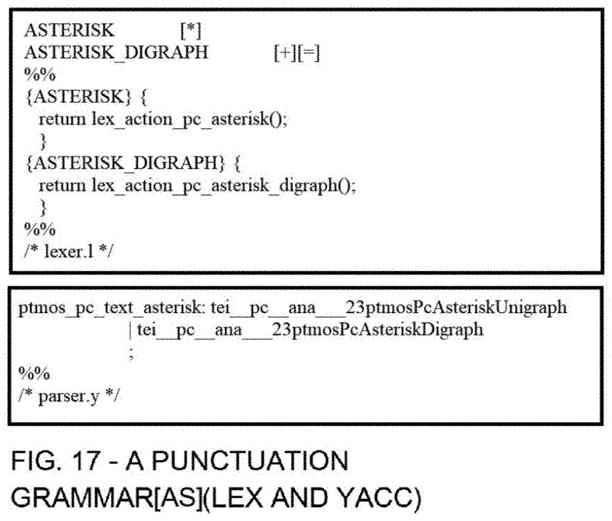

FIG. 17—A PUNCTUATION GRAMMAR [AS] (LEX AND YACC);

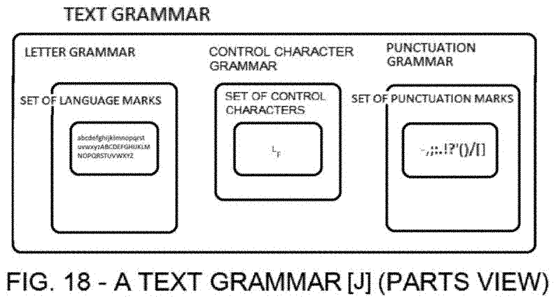

FIG. 18—A TEXT GRAMMAR [J] (PARTS VIEW);

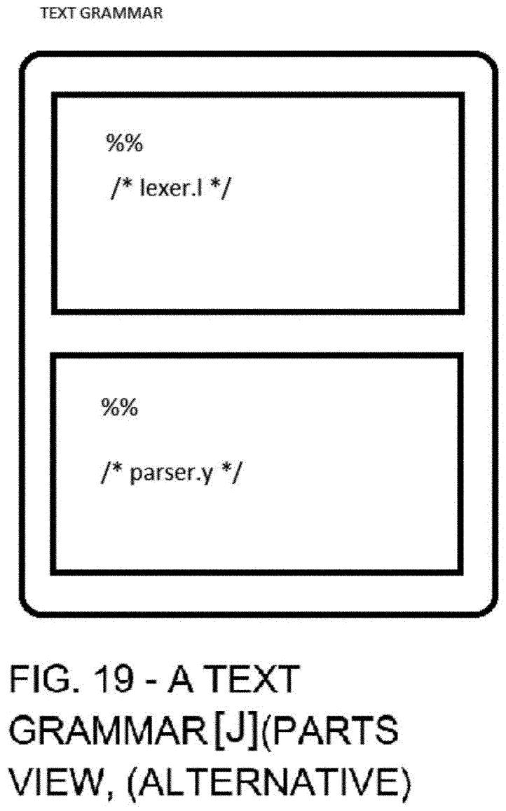

FIG. 19—A TEXT GRAMMAR [J] (PARTS VIEW, ALTERNATIVE);

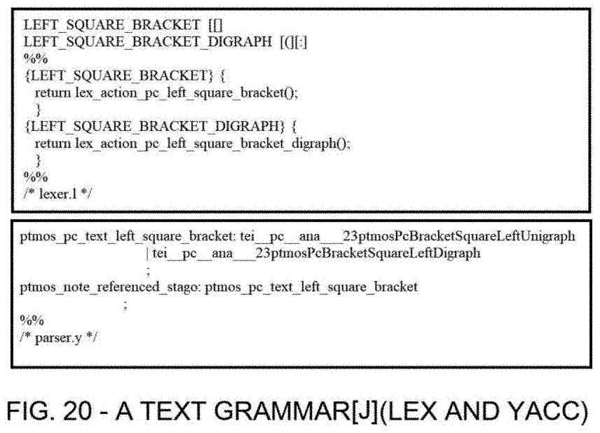

FIG. 20—A TEXT GRAMMAR [J] (LEX AND YACC);

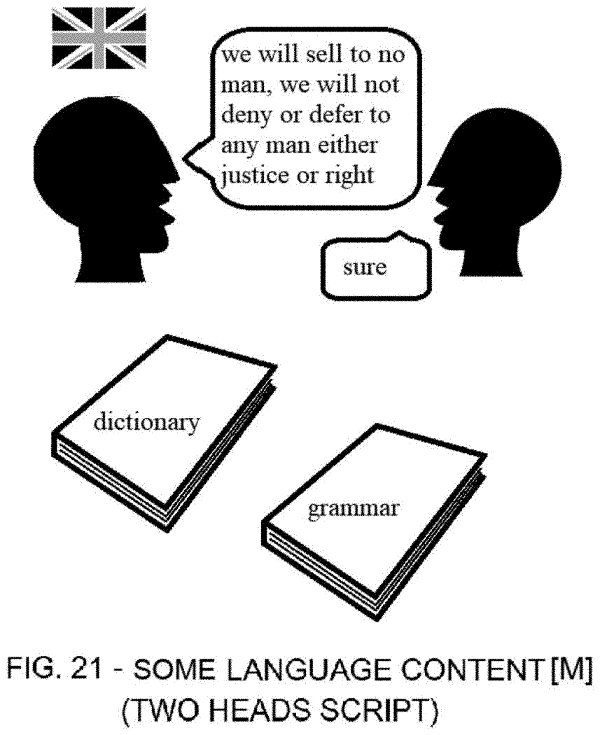

FIG. 21—SOME LANGUAGE CONTENT [M] (TWO HEADS SCRIPT);

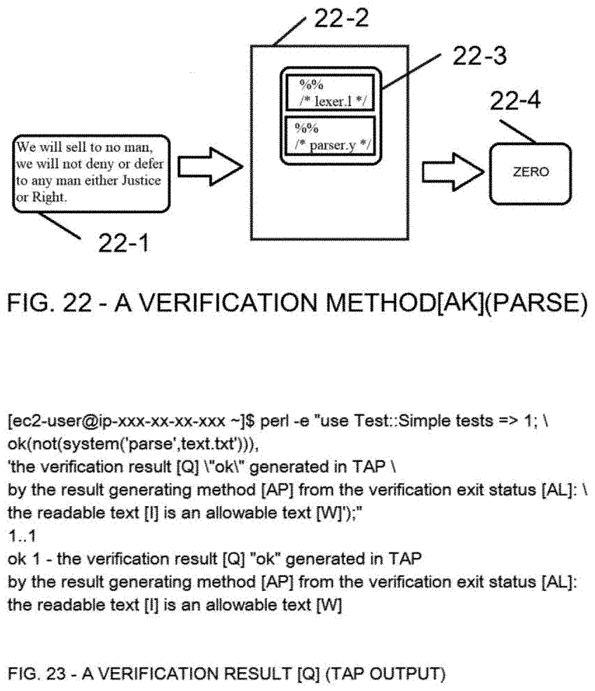

FIG. 22—A VERIFICATION METHOD [AK] (PARSE);

FIG. 23—A VERIFICATION PASS RESULT [Q] (TAP OUTPUT);

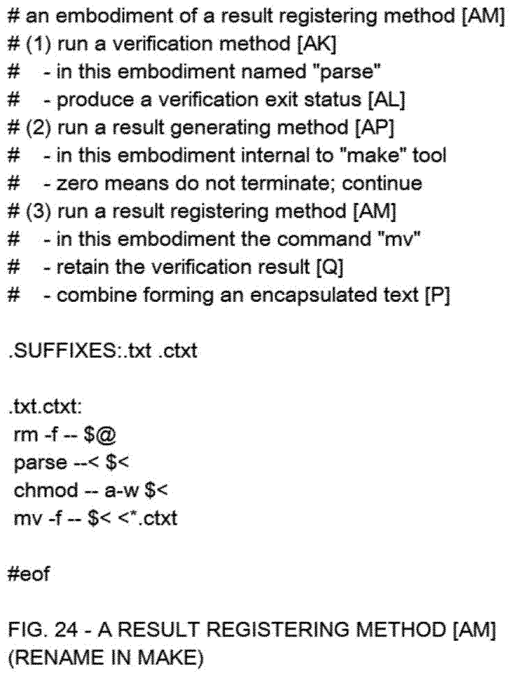

FIG. 24—A RESULT REGISTERING METHOD [AM] (RENAME IN MAKE);

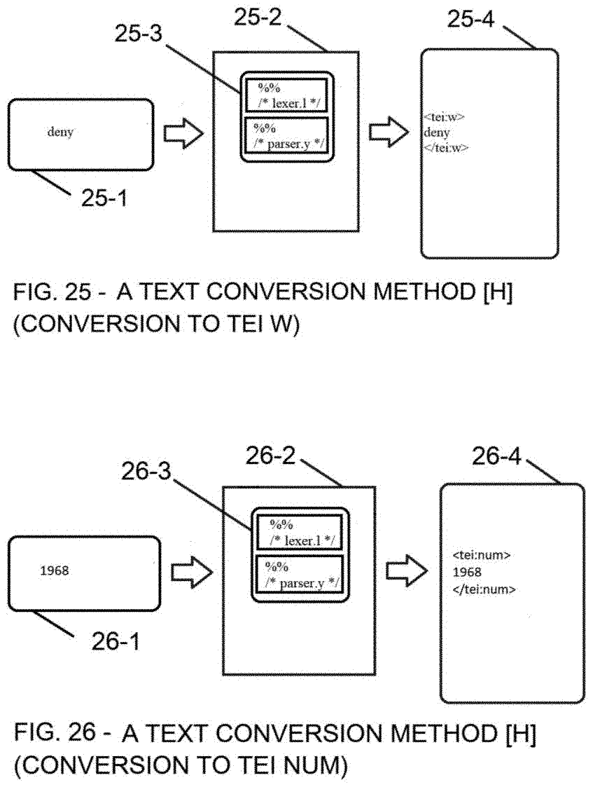

FIG. 25—A TEXT CONVERSION METHOD [H] (CONVERSION TO TEI W);

FIG. 26—A TEXT CONVERSION METHOD [H] (CONVERSION TO TEI NUM);

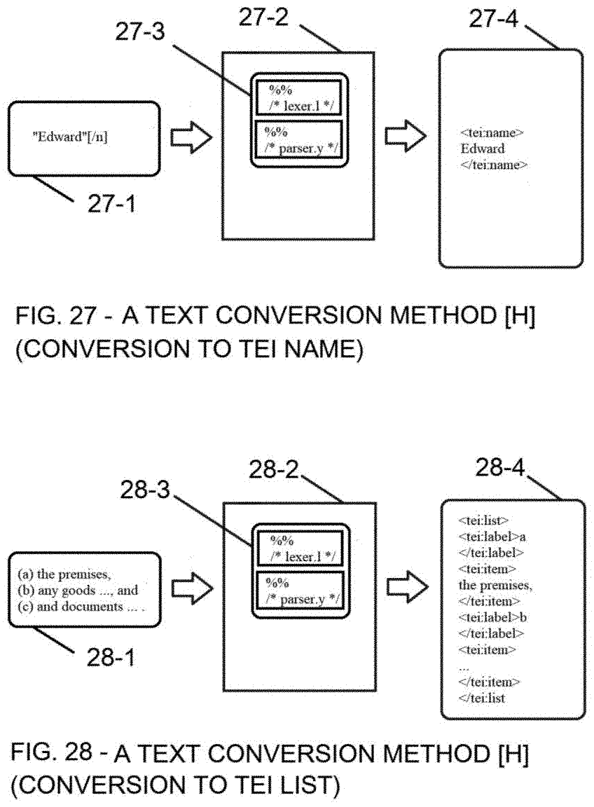

FIG. 27—A TEXT CONVERSION METHOD [H] (CONVERSION TO TEI NAME);

FIG. 28—A TEXT CONVERSION METHOD [H] (CONVERSION TO TEI LIST); and

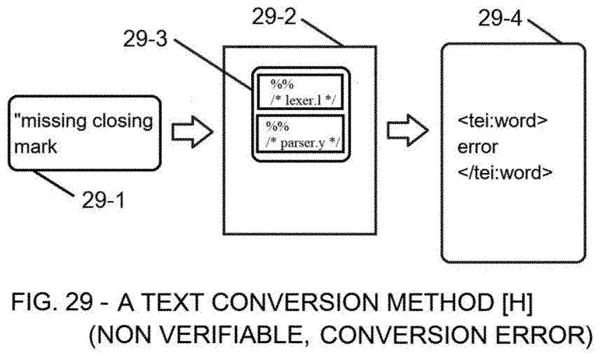

FIG. 29—A TEXT CONVERSION METHOD [H] (NON VERIFIABLE, CONVERSION ERROR).

### OVERVIEW

FIG. 1—captioned A CONVERTING METHOD [A]—illustrates a converting method [A] which converts an n-tuple [K]—comprising some language content [M] and some additional information [N]—to and from a document [L] using a readable text [I] and a text grammar [J]—according to embodiments.

FIG. 1A—captioned SOME LANGUAGE CONTENT [M] (TWO HEADS SPEAKING)—illustrates an example of some language content [M]—by showing it in a vocalised form—according to embodiments.

FIG. 2—captioned A READABLE TEXT [I] (SCRIPTIO CONTINUA)—illustrates an example of an element used in a converting method [A]—according to embodiments.

FIG. 3—captioned A READABLE TEXT [I] (HEXDUMP)—illustrates a second example of a readable text [I] when viewed with a computer utility—according to embodiments.

FIG. 4—captioned A MARKING METHOD [F] (PEN AND PAPER)—illustrates a third example of a readable text [I] and a lower technology example of a marking method [F]—according to embodiments.

FIG. 5—captioned AN ENCAPSULATED TEXT [P] (PAPER WITH TICK BOX)—illustrates an example of a result registering method [AM] for configuring a readable text [I] with a verification result [Q] as an encapsulated text [P]-according to embodiments.

FIG. 6—captioned AN ENCAPSULATED TEXT [P] (RENAMED FILE SUFFIX)—illustrates a second example of a result registering method [AM] for configuring a readable text [I] with a verification result [Q] as an encapsulated text [P]—according to embodiments.

FIG. 7—captioned A READABLE TEXT [I] (PUNCTUATION HIGHLIGHTS)—illustrates a first example of some additional information [N] merged into a readable text [I]—according to embodiments.

FIG. 8—A READABLE TEXT [1] (PUNCTUATION HIGHLIGHTS—LINE FEED)—illustrates a second example of some additional information [N] merged into a readable text [I]—according to embodiments.

FIG. 9—captioned A READABLE TEXT [I] (DISPLAYED LIST)—illustrates a third example of some additional information [N] merged into a readable text [I]—according to embodiments.

FIG. 10—captioned A READABLE TEXT [I] (MARKS OF INCLUSION)—illustrates a fourth example of some additional information [N] merged into a readable text [I]—according to embodiments.

FIG. 11—captioned A READABLE TEXT III (META-DATA)—illustrates a fifth example of some additional information [N] merged into a readable text [I]—according to embodiments.

FIG. 12—captioned A READABLE TEXT [I] (E ACUTE)—illustrates a an example using a multiset of characters [X] drawn from a limited set of characters [Y]—according to embodiments.

FIG. 13—captioned A SET OF LANGUAGE MARKS [AU] (LOWER CASE ENGLISH)—illustrates a set of language marks [AU] required by a readable text [I]—according to embodiments.

FIG. 14—captioned A SET OF PUNCTUATION MARKS [AV] (ENGLISH)—illustrates a set of punctuation marks [AV] required by a readable text [I]—according to embodiments.

FIG. 15—captioned A SET OF CONTROL CHARACTERS [AX] (LINE FEED)—illustrates a set of control characters [AX] required by a readable text [I]—according to embodiments.

FIG. 16—captioned A LETTER GRAMMAR [AR] (LEX AND YACC)—illustrates an element of a verification method [AK]—a letter grammar [AR]—itself an element of a text grammar [J]—according to embodiments.

FIG. 17—captioned A PUNCTUATION GRAMMAR [AS] (LEX AND YACC)—illustrates an element of a verification method [AK]—a punctuation grammar [AS]—itself an element of a text grammar [J]—according to embodiments.

FIG. 18—captioned A TEXT GRAMMAR [J] (PARTS VIEW)—illustrates a second alternative view of an element of a verification method [AK]—a text grammar [J]—according to embodiments.

FIG. 19—captioned A TEXT GRAMMAR [J] (PARTS VIEW, ALTERNATIVE)—illustrates a third alternative view of an element of a verification method (AK)—a text grammar [J]—according to embodiments.

FIG. 20—captioned A TEXT GRAMMAR [J] (LEX AND YACC)—illustrates an element of a verification method [AK]—a text grammar [J]—according to embodiments.

FIG. 21—captioned SOME LANGUAGE CONTENT [M] (TWO HEADS SCRIPT)—illustrates an example of an input to a converting method [A]—some language content [M]—by showing it in cartoon script form—according to embodiments.

FIG. 22—captioned A VERIFICATION METHOD [AK] (PARSE)—illustrates a verification method [AK] for parsing a readable text [I] and an example of an intermediate output element of a converting method [A]—a verification result [Q]—according to embodiments.

FIG. 23—captioned A VERIFICATION RESULT [Q] (TAP OUTPUT)—illustrates a second example of an intermediate output element of a converting method [A)—a verification result (Q]—according to embodiments.

FIG. 24—captioned A RESULT REGISTERING METHOD [AM] (RENAME IN MAKE)—illustrates a sub-method—a result registering method [AM]—according to embodiments.

FIG. 25, FIG. 26, FIG. 27, FIG. 28 and FIG. 29 all illustrate examples of a text conversion method [H] converting a post-verification text [R] element of an encapsulated text [P] to a document [L] compliant with a format [S], in this example a format [S] known as TEI XML—according to embodiments.

### DETAILED DESCRIPTION OF THE INVENTION

### Definitions

(allowable text) a text which is allowable according to a text grammar and which may or may not have been demonstrated to be so allowable by verification
(canonical form) ‘A canonical form is a clear-cut way of describing every object in the class, in a one-to-one way’ (Petkovsek et al 1997)
(computer grammar) ‘a set of rules governing what strings are valid or allowable in a language or text’ (Oxford)
(control characters) characters which are typically not displayed but are interpreted as a control functions ‘defined by their effects on a character-imaging input/output device’ (ECMA 48)
(descriptive markup) ‘indicates what a text element is or, in different terms, declares that a portion of a text stream is a member of a particular class’ (Coombs et al 1997)
(format) ‘a set of semantic and syntactic rules governing the mapping between abstract information and its representation in digital form’ (UDFR)
(normal form) ‘A normal form is a way of representing objects such that although an object may have many “names” ([that is, the canonical form] is a set), every possible name corresponds to exactly one object’ (Petkovsek et al 1997)
(plain text) a text containing mostly letters, digits, punctuation and so on, and only a very small set of control characters, typically limited to line and paragraph formatting
(presentational markup) Presentational markup is used to ‘mark up the higher-level entities in a variety of ways to make the presentation clearer. Such markup . . . includes horizontal and vertical spacing, folios, page breaks, enumeration of lists and notes, and a host of ad hoc symbols and devices’ (Coombs et al 1997)
(punctuational markup) ‘the use of a closed set of marks to provide primarily syntactic information about written utterances’ (Coombs et al 1997)
(encapsulated text) a post-verification text combined with a verification result following verification of a text
(text) written language which may or may not be plain text and may or may not be a verifiable text or a post-verification text
(text grammar) a computer grammar controlling whether a text is an allowable text or not
(verification) the method and the act of demonstrating that a text has been indeed been shown to be an allowable text or not, and that the text is now a post-verification text
(verification result) a result recording verification of a text, that is whether the text was an allowable text or not
(post-verification text) a text which has been verified, that is demonstrated to be allowed or not by a text grammar

### Acronyms and Abbreviations

### (ECMA) European Computer Manufactures Association

### (FSF) Free Software Foundation

### (GNU) Gnu's not Unix

### (IEC) International Electrotechnical Commission

### (ISO) International Organization for Standardization

### (ITU) International Telecommunications Union

### (SGML) Standard Generalized Markup Language

(XML) eXtensible Markup Language

### (TAP) Test Anything Protocol

### (TEI) Text Encoding Initiative

### (UCS) Universal Coded Character Set

### (UDFR) Unified Digital Formats Registry

### (UTF) Unicode (tm) or (UCS) Transformation Format

### (YACC) Yet Another Compiler Compiler

### Glossary

(2-tuple) a tuple with two ordered elements, an ordered pair
(Ecma) the name of ECMA since 1994
(ECMA-6) a ‘7-bit coded character set for information interchange’
(ECMA-48) ‘Control functions for 7-bit and 8-bit coded character sets’
(GNU) the name of an FSF project
(ISO/IEC 646) an ‘ISO 7-bit coded character set for information interchange’
(ITA2) the ‘ITU International Telegraph Alphabet No. 2’ as specified by ITU-T Recommendation S.1 extended to discriminate capital and small letters for potential use with coding scheme ITU-T Recommendation S.2
(IR-170) International Register entry 170, a 94 character graphic character set invariant in all versions of ISO/IEC 646
(lex) a computer utility program used to ‘generate programs for lexical tasks’ POSIX (tm)
(make) a computer utility program used to ‘maintain, update, and regenerate groups of programs’ POSIX (tm)
(multiset) a collection of elements where elements may be repeated, in contrast to a set where elements are not repeated
(n-tuple) a tuple with an unspecified number of ordered elements
(ordered pair) a 2-tuple
(plurality) a collection of more than one elements where elements may be repeated, that is a multiset which is both not empty and not a singleton
(set) a mathematical term for a collection of elements, with no elements repeated and here used to mean a set with no elements themselves being sets, a so called flat set or set of degree zero
(set of sets) a set consisting of elements which are themselves sets, a set of degree one, or a collection or a class of sets
(singleton) a set or multiset with a single element
(Test Anything Protocol) a protocol used in software testing
(tuple) an entity consisting of ordered elements, most specifically an ordered pair or 2-tuple and most generally an n-tuple with an unspecified number of ordered elements
(Unix) an operating system trademarked as UNIX by The Open Group
(yacc) a computer utility program which will ‘read a description of a context-free grammar . . . and write . . . a function and related routines and macros for an automaton that executes a parsing algorithm’ POSIX (tm), also known as YACC

Trademarks are identified in the description below by the trailing cue (tm).

The following terms are used below and are trademarks and may be registered in a variety of countries:

(+)

(−)

FSF

GNU

ISO

ITU

ITU-T

POSIX

PTMOS—The Plain Text Manual of Style

UNICODE

UNIX

‘A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.’

In the following text, characters are referred to by their Unicode (tm) names. Embodiments are not limited to using characters defined by such names, to using such names themselves or by any other aspects of related specifications.

Unless otherwise specified the term ‘set’ is used to mean a non-empty set, that is a set with one or more elements. Often the use of the term ‘comprises’ in the surrounding text ensures the meaning of ‘set’ is definitively that of a non-empty set.

‘Written language is a complicated structure and difficult to read. The “punctuational markup” used in writing is considered relatively complicated and subject to considerable stylistic variation . . . [and] is highly ambiguous.’ (Coombs et al 1997)

The invention is a converting method [A], converting between an n-tuple [K] and a document [L] using a readable text [I] and a text grammar [J]. An n-tuple [A] comprises some language content [M] and some additional information [N]. An n-tuple is therefore by definition a tuple with two or more elements, that is an order of two or more. A readable text [I] has two qualities, it is both readable using ordinary skills of reading, and valid in a text grammar [J], which is a computer grammar. It is a normal form of text. A text grammar [J] ensures a readable text [I] is rigorous. And yet, a readable text [I] contains additional punctuational, presentational and descriptional information so as to include the entirety of both some language content [M] and some additional information [N]. A text grammar [J] contains a rigorous set of punctuation idioms [AG] which may be constrained to be declarative, according to embodiments. The elements of an n-tuple [K] need not be related or tightly coupled, but one skilled in the art will recognise that embodiments may use a some additional information [N] element to hold information about a some language content [M] element of an n-tuple [K]. In other embodiments some additional information [N] may comprise non-language content such as multi-media content.

Inventing such a converting method [A] requires an inventive combination and uncommon knowledge of a mosaic of many varied, non-obvious, unexpected, cluttered and remote sources on writing.

The converting method [A] is between two forms and the method in embodiments may be bi-directional, reversible and loss-less. There are no temporal restraints on the method, that is there is no implied order in the conversion and embodiments may undertake conversion in any order, in parallel or sequentially in either direction. The method will generally be described as operating in the direction from an n-tuple [K] to a document [L], with one skilled in the art able to understand the reverse method without further information.

The invention within the scope of the appended claims has the following independent claim sets:

a converting method [A]

a computer-readable memory device [B]

a computing device [C]

The converting method [A] may have the following steps, each step referred to as a subsidiary method:

an orthographic method [D]

a text creation method [E]

a marking method [F]

a text encapsulation method [G]

a text conversion method [H]

The converting method [A] and subsidiary methods, the computer-readable memory device [B] and the computing device [C] may have the following elements (in order of first use in the appended claims):

a readable text [I]

a text grammar [J]

an n-tuple [K]

a document [L]

some language content [M]

some additional information [N]

some pointed annotated written language [O]

an encapsulated text [P]

a verification result [Q]

a post-verification text [R]

a format [S]

a set of formats [T]

a medium [U]

a set of mediums [V]

an allowable text [W]

a multiset of characters [X]

a limited set of characters [Y]

a context free grammar [Z]

a lex description [AA]

a YACC grammar [AB]

a set of text grammar rules [AC]

a multiset of terminal and non-terminal symbols [AD]

an encoded terminal or non-terminal symbol [AE]

a set of text grammars [AF]

a rigorous set of punctuation idioms [AG]

a multiset of instructions [AH]

a processor [AI]

a reader application [AJ]

The preceding and following description are only illustrative of the principles of the invention. In the description below the following elements and method steps are introduced to enhance the description of an embodiment of the invention within the scope of the appended claims.

a verification method [AK]

a verification exit status [AL]

a result registering method [AM]

a pointing method [AN]

an annotating method [AO]

a result generating method [AP]

a language [AQ]

a letter grammar [AR]

a punctuation grammar [AS]

a control character grammar [AT]

a set of language marks [AU]

a set of punctuation marks [AV]

a set of graphic characters [AW]

a set of control characters [AX]

a set of characters [AY]

a set of sets of graphic characters [AZ]

a set of sets of control character [BA]

a multiset of language marks [BB]

a multiset of punctuation marks [BC]

a second multiset of punctuation marks [BD]

the ITA2 character repertoire [BE]

the IR-170 graphic character repertoire [BF]

the IRV version of the ECMA-6 graphic character repertoire [BG]

the C0 set of ECMA-48 plus SPACE [BH]

a second context free grammar [BI]

a multiset of XML element start-tags [BJ]

a multiset of TEI element start-tags [BK]

FIG. 1—captioned A CONVERTING METHOD [A]—illustrates a converting method [A] which converts an n-tuple [K]—comprising some language content [M] and some additional information [N]—to and from a document [L] using a readable text [I] and a text grammar [J]—according to embodiments.

One industrial application of some embodiments is to convert from an n-tuple [K] to a document [L] wherein the document is publishable in a medium [U] such as a book, a magazine, a journal, a newspaper, an article, or a web page. In these embodiments the additional information [N] of the n-tuple [K] contains the information required to produce a publication from the language content [M]. A set of mediums [V] comprises one or more elements of a medium [U] according to the appended claims and is therefore not an empty set.

One such publishing embodiment was used to publish the printed book ISBN 9780995726109 which states in the colophon ‘Converted from ptmos formatted plain text by ptmos-0.00.097’ and on the copyright page ‘Typescript source formatted in “PTMOS—The Plain Text Manual of Style”’ (Copyright 2017 Jonathan Vyse).

Some language content [M] and some additional information [N] can be readily visualised in an understandable way as written language. These elements are illustrated in this way in the description below by way of their appearance in an element named a readable text [I], an element used as part of a converting method [A]. Embodiments are not restricted to the use of written language to implement these elements of the n-tuple [K] and the reader should not confuse a concrete visible written form, such as a readable text [I], used for illustration purposes only, with the elements of the n-tuple [K].

A readable text [I] may or may not be an allowable text [W]; this is decided by subjecting a readable text [I] to verification. Visualisations of some language content [M] and some additional information [N], illustrated as a readable text [I], will usually be chosen, in this description, to be an allowable text [W], that is, the visualisations will be chosen so as to be ones which would be verified as an allowable text [W]. Readers should not assume from this idealisation that a readable text [I] is always allowable, merely usually illustrated as one, unless otherwise indicated, for the sake of useful and easy illustration.

FIG. 1A—captioned SOME LANGUAGE CONTENT [M] (TWO HEADS SPEAKING)—illustrates an example of some language content [M]—by showing it in a vocalised form—according to embodiments.

The speaker has created some language content [M] in a language [AQ] in an audible form shown with figure label [1-1]—so called spoken language. A language [AQ] is indicated in this figure by the figure label [1-2]. Embodiments are not limited to the English language, nor do embodiments need some language content [M] to be vocalised, it may be generated by a computer and, for example, received over a communications link.

FIG. 2—captioned A READABLE TEXT [I] (SCRIPTIO CONTINUA)—illustrates an example of an element used in a converting method [A]—according to embodiments.

It may be desirable to store the language content [M] shown with figure label [1-01], for example it may be judged to be potentially useful at a later time. In FIG. 2 the language content [M] in FIG. 1 has been subjected to further methods producing an intermediate output in written form—a readable text [I].

In FIG. 2 the readable text [I] is an embodiment in an orthography here named scriptio continua. A multiset of language marks [BB] used in this example has been drawn from a set of language marks [AU], such as that example set illustrated in FIG. 13, and a multiset of punctuation marks [BC] drawn from a set of punctuation marks [AV], such as that set illustrated in FIG. 14, in FIG. 2, a multiset of punctuation marks [BC] is empty, a characteristic of the scriptio continua orthography used in this example. Similarly a rigorous set of punctuation idioms [AG] in this example may be empty; it is not possible to know, it may simply be that none are used in this example. Embodiments are not limited to scriptio continua or any particular instance of a set of language marks [AU] or any particular instance of a set of punctuation marks [AV] or any particular instance of a rigorous set of punctuation idioms [AG].

A set of graphic characters [AW] is the union of two distinct sets: a set of language marks [AU] and a set of punctuation marks [AV]. A set of characters [AY] is the union of two distinct sets: a set of graphic characters [AW] and a set of control characters [AX]. A multiset of characters [X] is drawn from a set of characters [AY], which may or may not be a limited set of characters [Y]. The term ‘limited’ is unspecified except that a ‘limited set’ is not an empty set. Furthermore, a set of graphic characters [AW] must be non-empty in a readable text [I], although in FIG. 2 a set of punctuation marks [AV] may have been an empty set. A further limitation of the minimum size of both a set of characters [AY] and a multiset of characters [X] drawn from it is the need to represent some language content [M] and some additional information [N] in a readable text [I] which must have characters to be readable.

FIG. 3—captioned A READABLE TEXT [I] (HEXDUMP)—illustrates a second example of a readable text [I] when viewed with a computer utility—according to embodiments.

A marking method [F] creates the final form of a readable text [I], for example by using individual marks drawn from a set of graphic characters [AW] and a set of control characters [AX], according to embodiments. Embodiments may represent such marks in a variety of electronic or physical ways, they could, for example, be stored as codes or as patterns of bits forming glyphs or drawn or printed or painted in ink on paper or etched in gold by laser.

A readable text [I] may be conveniently interchanged or stored by computer with characters represented as numbers or codes. In this illustration, FIG. 3, a readable text [I] is represented by the series of codes shown within the box marked by figure label [3-1], and this series of codes has been configured by an embodiment of a marking method (F) from key presses on a computer keyboard. Information interchange is eased if codes are standardised. Embodiments are not restricted to using computers or any particular character codes, standardised or not.

One skilled in the art will recognise FIG. 3 as a screenshot of the input and output to the Unix (tm) utility ‘od’ used to ‘dump’ data in various formats. The hexadecimal numbers shown by figure label [3-1] represent part of the ‘dump’ or output of the utility, a part which is not readable by one ordinarily skilled in the art of reading text. The input to the utility is contained in the command invoking ‘od’ at the top of the FIG. 3. The characters surrounding the figure label [3-2] also form part of the output but are readable by one ordinarily skilled in the art of reading, as is the input to the utility.

In this embodiment, the third character, SPACE, has been represented by hexadecimal 20 (decimal 32, U+0020), and the twenty fourth character, LINE FEED, here representing the control function of moving to the next line, has been represented by hexadecimal 0a (decimal 10, U+000A) as shown by figure labels [3-2] and [3-3]. The FULL STOP mark shown at figure label [3-2] represents a visible form of the LINE FEED mark in this ‘dump’. In other figures, for example FIG. 15, the LINE FEED mark is represented by an alternative visual representation, a Unicode (tm) character U+240A which appears as ‘LF’ and has no control function.

One skilled in the art of reading will notice in FIG. 3 the SPACE character, representing some additional information [N] related to word separation, has been merged into the scriptio continua text shown in FIG. 2. This use of SPACE to mark word separation is an element in a rigorous set of punctuation idioms [AG], according to embodiments. Similarly, LINE FEED marking a line break is an element in a rigorous set of punctuation idioms [AG] according to embodiments.

FIG. 4—captioned A MARKING METHOD [F] (PEN AND PAPER)—illustrates a third example of a readable text [I] and a lower technology example of a marking method [F]—according to embodiments.

A readable text [I] may be conveniently stored using a lower technology embodiment of a marking method [F] which uses a pen to render marks on paper, as illustrated in FIG. 4. This is a best mode embodiment in limited circumstances, for example storage for over one hundred years or perhaps one thousand years on velum, and is a mode used here for illustration. A best mode embodiment for more common circumstances is shown in FIG. 3. Embodiments are not restricted to using any particular writing medium or implements or method, for example, in tangible embodiments, a pen could be driven by robotics or a printer may be used or a laser etching technique or codes could be stored in or transmitted by computers.

Embodiments use an orthographic method [D] to create some pointed annotated written language [O], although the details of the structure of some pointed annotated written language [C] may vary according to embodiments. Embodiments use a text creation method [E] to convert some pointed annotated written language [O] into a readable text [I] using a marking method [F], although the details of the format of a readable text [I] vary according to embodiments and so the choice of a marking method [F] will also vary accordingly. One embodiment structures some pointed annotated written language [O] using the Unicode (tm) encoding model and the coded character set (CCS) known as Version 4.0 ISO/EC 10646:2003. Such an embodiment may have a text creation method [E] which creates a readable text [I] as a computer file with characters encoded in a 7-bit Character Encoding Form (CEF), such as ISO 646. Such an embodiment may write to a file, 7 bits to the byte, in a simple Character Encoding Scheme (CES), one which trivially uses bytes of the same value in an identity CES.

Although the structure of some pointed annotated written language [O] varies between embodiments, the distinguishing feature of the boundary between an orthographic method [D] and a text creation method [E] is that an orthographic method [D] completes the choice of elements drawn from a rigorous set of punctuation idioms [AG], that is some pointed annotated written language [O] has a structure only analogous to a readable text [I] but possibly not actually readable, for example because its words are stored as integer indexes into a dictionary. In this way an embodiment of a text creation method [E] can be considered as merely reducing a structure analogous to a readable text [I] into an actual instance of a readable text [t]. An implication of this boundary between an orthographic method [D] and a text creation method [E], for example, is that some pointed annotated written language [O] may not be readable when stored in a file, according to some embodiments, without a file viewer specific to that particular embodiment.

FIG. 5—captioned AN ENCAPSULATED TEXT [P] (PAPER WITH TICK BOX)—illustrates an example of a result registering method [AM] for configuring a readable text [I] with a verification result [Q] as an encapsulated text [P]—according to embodiments.

There is a need to know whether a readable text [I] is or is not an allowable text [W] according to a text grammar [J]. An encapsulated text [P] is an ordered pair of a readable text [I] and a verification result [Q], configured by a result registering method [AM]. In the embodiment illustrated in FIG. 5, a written tick in a circle shown by figure label [5-1] is used as a verification result [Q]. A readable text [I] shown by figure label [5-2] is further processed by a result registering method [AM] into an encapsulated text [P] by adding a verification result [Q] directly on to the paper as a written mark, combining the two component elements together into a single output element.

In the appended claims, this method of converting between a readable text [I] and an encapsulated text [P] using a text grammar [J] is named a text encapsulation method [G].

Embodiments are not restricted to combining the two component elements of an encapsulated text [P] together and may associate a verification result [Q] with a readable text [I] in other ways. Such embodiments may have a looser association between the elements.

A readable text [I] which is not an allowable text [W] will produce a ‘fail’ verification result [Q] and may be marked by embodiments in a different way to those producing a ‘pass’. For example, many utilities output nothing on failure, that is the mere existence of an output represents a ‘pass’, and such methods prevent the creation of outputs which are anything other than ‘pass’ outputs. In such embodiments, a result registering method [AM] may be considered to have stored a verification result [Q] in a set of such results; a set which may be empty before and after the result is stored in the case of a ‘fail’.

A sub-method of a text encapsulation method [G] is known as a verification method [AK]. A readable text [I], after a verification method [AK] has been applied, is known as a post-verification text [R].

FIG. 6—captioned AN ENCAPSULATED TEXT [P] (RENAMED FILE SUFFIX)—illustrates a second example of a result registering method [AM] for configuring a readable text [I] with a verification result [Q] as an encapsulated text [P]—according to embodiments.

In a second illustration of an embodiment of a result registering method [AM], shown in FIG. 6, a change is made to the file name containing a readable text [I] to signify a readable text [I] is an allowable text [W]. A readable text [I] labelled [6-1] is marked as an encapsulated text [P] shown with figure label [6-5] by a result registering method [AM] shown with figure label [6-4], recording a ‘pass’ verification result [Q] shown with figure label [6-3] directly into the name of the file. In this embodiment the renaming occurs by pre-pending the letter ‘c’, standing for ‘correct’, to the file name suffix, changing it from ‘.txt’ to ‘.ctxt’. The original file name labelled [6-2] is changed to a different file name shown with figure label [6-6]. Embodiments are not limited to any particular file renaming scheme or to renaming at all or to even using files.

FIG. 7—captioned A READABLE TEXT [I] (PUNCTUATION HIGHLIGHTS)—illustrates a first example of some additional information [N] merged into a readable text [I]—according to embodiments.

Some language content [M] in scriptio continua orthography is hard to read but remains readable, as a readable text [I] illustrated in FIG. 2 shows. The same language content [M] is made easier to read by applying a pointing method [AN], resulting in a another example of a readable text [I] illustrated in FIG. 7 according to embodiments. This method has merged in the punctuation marks known as SPACE, some of which are shown with figure label [7-4], COMMA with figure label [7-5] and FULL STOP with figure label [7-6]. Other characters in FIG. 7, such as those marking line breaks, are not highlighted. In some embodiments, SPACE is considered a control character.

In this illustration, FIG. 7, an embodiment has merged in word boundaries and sentence termination and more from some additional information [N]. It has merged a multiset of punctuation marks [BC] into the language content [M] by a pointing method [AN]. FIG. 14, illustrates an embodiment of a set of punctuation marks [AV] from which a multiset of punctuation marks [BC] has been drawn for use in FIG. 7. This merging of some additional information uses further elements in a rigorous set of punctuation idioms [AG] according to embodiments.

Variations in usage of a multiset of language marks [BB] drawn from a set of language marks [AU] can also merge some additional information [N] into the language content [M] and so provide further reading aids. This is shown by the upper case letters with figure labels [7-1], [7-2] and [7-3]. Another example is the use of heterographs, variant spelling of homephones, that is words which sound the same but which are written with variant letters. FIG. 7 comprises the example heterographs ‘to’ (‘two’ and so on), ‘not’ (‘knot’), ‘or’ (‘oar’ and so on).

Embodiments are not limited any particular instance of a pointing method [AN], any particularly instance of a set of punctuation marks [AV].any particular instance of a set of language marks [AU], nor any particular instance of some additional information [N], nor any particular instance of a rigorous set of punctuation idioms [AG]. For example, FIG. 13 illustrates an embodiment of a set of language marks [AU] for English, but a set which lacks the upper case or capital letters. Such an embodiment can not directly include capitonymns, words with different meanings when capitalised.

FIG. 8—A READABLE TEXT [I] (PUNCTUATION HIGHLIGHTS—LINE FEED)—illustrates a second example of some additional information [N] merged into a readable text [I]—according to embodiments.

The embodiment in FIG. 8 illustrates a readable text [I] similar to that in FIG. 7 except the character known as LINE FEED and with figure label [8-1] is replaced with a visual representation, Unicode (tm) character U+240A, rather than the more usual control function effect of moving to the next line when outputting. In FIG. 3 the same LINE FEED character was visualised in two ways in the output: as FULL STOP, shown within the area highlighted with figure label [3-2]; and as ‘0a’, shown similarly with figure label [3-3]. FIG. 15 illustrates a set of control characters [AX], according to embodiments.

FIG. 9—captioned A READABLE TEXT [I] (DISPLAYED LIST)—illustrates a third example of some additional information [N] merged into a readable text [I]—according to embodiments.

The amount of some additional information [N] which an be merged into a readable text [I] by a pointing method [AN] can be further expanded, beyond that illustrated in FIG. 7, whilst remaining readable by one ordinarily skilled at reading the language. For example, in FIG. 9, an embodiment is illustrated where three HYPHEN MINUS punctuation marks labelled [9-5] configures a DASH typographic mark. This represents a trigraph idiom as an element in a rigorous set of punctuation idioms [AG] used in this embodiment.

In other examples from FIG. 9, three SPACE punctuation marks, hard left, followed by a LEFT PARENTHESIS punctuation mark shown with figure label [9-1] configures the opening of the highest level of a displayed list: a RIGHT PARENTHESIS, two examples shown with figure labels [9-3] and [9-4], configures the end of any label of such a list item. Six SPACE punctuation marks, hard left, followed by a LEFT PARENTHESIS, three examples shown with figure label [9-2], configures a list within a list, a so called nested list. This use of punctuation is another element in a rigorous set of punctuation idioms [AG] according to embodiments.

Embodiments are not limited to lists and DASH typographic marks. The extent of some additional information [N] may be expanded further in other embodiments. A pointing method [AN] includes any use of marks from a set of punctuation marks [AV] other than usage defined as being an annotating method [AO]. In other embodiments, methods in addition to pointing or annotation may be used to add further idioms to the elements in a rigorous set of punctuation idioms [AG].

This set of methods for merging some additional information [N] into some language content [M] produces an output named some pointed annotated written language [O] in the claims attached. The use of the words ‘pointed’ and ‘annotated’ in the name is not intended to limit the number of methods of augmentation to two, a pointing method [AN] and an annotating method [AO], merely to provide an informative but concrete name. Nor should the use of the word ‘written’ be read as inferring text, for example some embodiments may store some pointed annotated written language [O] with words as numbers indexing into a dictionary, for example the word ‘a’ may be indexed by the number 1.

FIG. 10—captioned A READABLE TEXT [I] (MARKS OF INCLUSION)—illustrates a fourth example of some additional information [N] merged into a readable text [I]—according to embodiments.

Some additional information [N] may also be merged by an annotating method [AO], a method which further expands the amount of additional information [N] merged with some language content [M]. An annotating method [AO] configures some text with a second multiset of punctuation marks [BD] drawn from a set of punctuation marks [AV] by placing the text between a pair of those punctuation marks to enclose the text and so indicate by its inclusion that it is text of an exceptional nature. These marks of inclusion are followed by further punctuation marks, possibly in combination with other language marks, to indicate more information about the text's exceptional nature. The use of marks of inclusion with further marks differentiates an annotating method [AO] from a pointing method [AN]. Embodiments are not limited to only these two methods of merging some additional information [N]. Embodiments are not limited to using a second multiset of punctuation marks [BD] which is distinct from a multiset of punctuation marks [BC].

In embodiments, as illustrated in FIG. 10, two of the English punctuation marks of inclusion known as QUOTATION MARK are configured with LEFT SQUARE BRACKET, SOLIDUS, the language mark LATIN SMALL LETTER N, and RIGHT SQUARE BRACKET, shown with figure label [10-1], to annotate an individual's name and so add some additional information [N], the fact that the text represents a name. This information is over and above that conveyed in the examples above; examples which merely hint at the same by using context. This use of punctuation is an additional element in a rigorous set of punctuation idioms [AG] according to embodiments.

Using an annotating method [AO], a readable text [I] remains readable by one ordinarily skilled at reading the language. Embodiments are not limited to using QUOTATION MARK as a mark of inclusion, nor the use of LEFT SQUARE BRACKET. SOLIDUS and RIGHT SQUARE BRACKET, or any other marks of inclusion, to mark the type of the inclusion, nor the use of LATIN SMALL LETTER N or any other language mark or punctuation mark to indicate any particular information.

In embodiments, other marks of inclusion, for example QUOTATION MARK or LEFT SQUARE BRACKET and RIGHT SQUARE BRACKET, can, by an annotating method [AO], be used to merge some additional information [N] into some language content [M], for example by defining QUOTATION MARK to mark included text as direct speech or LEFT SQUARE BRACKET and RIGHT SQUARE BRACKET to mark included text as the voice of someone other than the author of the surrounding text. A pointing method [AN] allows only one usage for each pair of marks of inclusion, unless it is combined with other marks, as in FIG. 9, for an embodiment of lists, or an embodiment of an annotating method [AO] is used instead, as in FIG. 10. These usages of punctuation are additional elements in a rigorous set of punctuation idioms [AG] according to embodiments.

FIG. 11—captioned A READABLE TEXT [I] (META-DATA)—illustrates a fifth example of some additional information [N] merged into a readable text [I]—according to embodiments.

Some additional information [N] merged into a readable text [I] by a pointing method [AN] can be expanded still further using the embodiment of lists in yet further embodiments by configuring the list labels to be of special significance in certain sections within a readable text [I]. This is illustrated in FIG. 11 where list opening marks, used in a similar embodiment to FIG. 9, are shown with figure label [11-1].

In this embodiment some additional information [N] is extended to comprise information about the language content [M] itself, so called meta data; information such as title, year of publication and other source identifiers. Yet a readable text [I] remains readable by one ordinarily skilled at reading the language. In the illustration the figure label [11-2] identifies parts of the drawing which are figurative only; intended to make clear the concept of meta-data by comparing it to that of a library index card attached by a paper-clip. In yet other embodiments the additional information [N] comprises meta-data such as study notes or translations. This use of punctuation is an additional element in a rigorous set of punctuation idioms [AG] according to embodiments.

FIG. 12—captioned A READABLE TEXT [I] (E ACUTE)—illustrates a an example using a multiset of characters [X] drawn from a limited set of characters [Y]—according to embodiments.

In embodiments, a set of language marks [AU] and a set of punctuation marks [AV] may not contain all the marks required to write a language [AQ]. Additional marks can be configured by an annotating method [AO] according to embodiments. One embodiment marks an editorial intervention by LEFT SQUARE BRACKET and RIGHT SQUARE BRACKET marks of inclusion. This embodiment configures the type of the editorial intervention as that of an insertion of extended language marks using a LEFT SQUARE BRACKET, PLUS SIGN, the language mark LATIN SMALL LETTER U, and RIGHT SQUARE BRACKET. This embodiment is adding the ability to use a multiset of characters [X] drawn from a limited set of characters [Y], further extending the techniques which can be used to combine some additional information [N] with some language content [M]. Other embodiments are possible. This use of punctuation is an additional element in a rigorous set of punctuation idioms [AG] according to embodiments.

A short phrase containing two marks, LATIN SMALL LETTER E ACUTE followed by HORIZONTAL ELLIPSIS, is shown in FIG. 12. These two marks have figure label [12-1] for identification. These two marks are typically not included in a limited set of characters [Y] according to embodiments.

In one embodiment of editorial intervention using an annotating method [AO] to insert extended language marks, figure label [12-2], the names of the marks are used as part of the replacement of the marks themselves, with multiple mark names separated by SEMI COLON. In this embodiment the names used are from the Unicode (tm) standard, with the LOW LINE mark replacing spaces. Other embodiments may use other naming standards or other methods to insert extended language marks. These uses of punctuation are additional elements in a rigorous set of punctuation idioms [AG] according to embodiments.

Another embodiment uses a UTF-16 big-endian hexadecimal encoding of the additional language marks as the editorial intervention. Each encoded language mark consisting of a sequence of SPACE separated pairs of adjoining hexadecimal digits, with leading 00's omitted. Each sequence is separated by a SEMI COLON. No Byte Order Mark precedes the first sequence. An example of this embodiment has figure label [12-3]. In this embodiment the UTF-16 encoding of the two marks LATIN SMALL LETTER E ACUTE followed by HORIZONTAL ELLIPSIS is shown. Such an embodiment is not a best embodiment for readability of the text, as a table may be required by the reader to decode the hexadecimal digits.

FIG. 13—captioned A SET OF LANGUAGE MARKS [AU] (LOWER CASE ENGLISH)—illustrates a set of language marks [AU] required by a readable text [1]—according to embodiments.

A set of language marks [AU] required to write a language [AQ] may vary according to embodiments. One English language embodiment is illustrated in FIG. 13 comprising LATIN SMALL LETTER A. LATIN SMALL LETTER B, and so on. Additional upper case or capital letters may be used for English language embodiments. For example, in FIG. 7 the figure labels [7-1], [7-2] and [7-3] illustrate the letters LATIN CAPITAL W, LATIN CAPITAL R and LATIN CAPITAL J, respectively. In embodiments which do do support direct encoding of such capital letters, the method illustrated in FIG. 12, as described above, or other methods, may be used.

FIG. 14—captioned A SET OF PUNCTUATION MARKS [AV] (ENGLISH)—illustrates a set of punctuation marks [AV] required by a readable text [I]—according to embodiments.

A set of punctuation marks [AV] required to write a language [AQ] may vary according to embodiments. One English language embodiment is illustrated in FIG. 14 comprising HYPHEN MINUS, COMMA, SEMICOLON, COLON, FULL STOP, EXCLAMATION MARK, QUESTION MARK, APOSTROPHE, LEFT PARENTHESIS, RIGHT PARENTHESIS, SOLIDUS, LEFT SQUARE BRACKET, RIGHT SQUARE BRACKET, and QUOTATION MARK.

FIG. 15—captioned A SET OF CONTROL CHARACTERS [AX] (LINE FEED)—illustrates a set of control characters [AX] required by a readable text [I]—according to embodiments.

The description above is of a rigorous set of punctuation idioms [AG], which is not empty. Embodiments may use a variety of elements in a rigorous set of punctuation idioms [AG] and are not restricted to any particular instance of a rigorous set of punctuation idioms [AG] nor to any particular punctuation idiom. Embodiments are constrained in the elements which are included in a rigorous set of punctuation idioms [AG] as described elsewhere in this text.

In this description the following elements of a rigorous set of punctuation idioms [AG] are an illustration which comprises parts of an embodiment and are not a complete illustration of any particular embodiment. The illustrated punctuation idioms can be described as comprising:
word separation with SPACE
line breaking with LINE FEED
ASTERISK represented by a digraph of PLUS SIGN and EQUALS SIGN
DASH represented by a trigraph of three contiguous HYPHEN MINUS
displayed list labels comprising SPACE indenting and parenthesis
displayed list bullet labels comprising PLUS SIGN, HYPHEN MINUS, EQUALS SIGN and so on
meta-data with displayed lists with keyword labels
flush and hang paragraphs with single SPACE hang
exceptional text contained in marks of inclusion extended with addition in-text cues
exceptional text to mark editorial interventions and in-text cues
left aligned editorial interventions to mark note text targeted by an in-text cue
exceptional text to include extended language marks

A set of control characters [AX] is configured with a structure known as a control character grammar [AT]. One embodiment configures a set of control characters [AX] to contain LINE FEED and SPACE. Yet other embodiments may consider the character SPACE to belong in a set of punctuation marks [AV].

Embodiments may use a limited set of characters [Y] which consists of a set of control characters [AX] and a set of graphic characters [AW], graphic characters being visible and not elements of a set of control characters [AX]. A set of graphic characters [AW] is drawn from a set of sets of graphic characters [AZ] which comprises two or more of a sets of graphic characters [AW] from: the ITA2 character repertoire [BE], the IR-170 graphic character repertoire [BF], and the IRV version of the ECMA-6 graphic character repertoire [BG]. A set of control characters [AX] is drawn from a set of sets of control characters [BA] which comprises two or more of a set of control characters [AX] from: the ITA2 character repertoire [BE], and the C0 set of ECMA-48 plus SPACE [BH]. Other embodiments may use a character repertoire with fewer characters or one with more characters, such as Unicode (tin). These repertoires and character sets are literal names referencing sources of information external to this description. Although these source names include the terms ‘repertoire’ and ‘set’ these terms are to be interpreted in the context of the documents to which they refer.

Embodiments using a limited set of characters [Y] may operate on wide variety of simpler equipment. Some embodiments may use use ‘plain text’. Such embodiments may increase the longevity of any such text and provide a long term use for the equipment, deferring obsolescence. Increasing the longevity of text or of equipment or allowing the use of simpler equipment could all provide industrial applications for embodiments.

FIG. 16—captioned A LETTER GRAMMAR [AR] (LEX AND YACC)—illustrates an element of a verification method [AK]—a letter grammar [AR]—itself an element of a text grammar [J]—according to embodiments.

A set of language marks [AU] is configured within a structure called a letter grammar [AR], according to embodiments. One embodiment, illustrated in FIG. 16, configures a set of language marks [AU] to contain LATIN SMALL LETTER A to LATIN SMALL LETTER Z and LATIN LARGE CAPITAL A to LATIN CAPITAL LETTER Z using a structure suitable for a tool known as lex; a structure known as a lex description [AA], used to generate a lexer. In this embodiment a sequence of one or more marks from a set of language marks [AU] is considered significant and requiring action to be taken during the operation of a lexer. In this embodiment a letter grammar [AR] structure is further configured using a structure suitable for a tool known as yacc; a structure known as a YACC grammar [AB], used to generate a parser. A YACC grammar [AB] is an embodiment of a context free grammar [Z] which is itself an embodiment of a set of text grammar rules [AC], a set with one or more elements.

In this embodiment, the sequence of one or more marks from a set of language marks [AU] is processed as a yacc token with the name tei_w, representing a TEI element for ‘word’. FIG. 16 is not a complete embodiment, merely a partial illustration suitable to inform one skilled in the art. The yacc token named tei__num hints at further parts of the embodiment. In this embodiment, a set of control characters [AX] is either not shown or is implicit implemented by the tools used, lex and yacc.

Embodiments might use a lexer and parser, for example, as part of a verification method [AK], a method whereby a readable text [I] is verified.

In this embodiment, the names of tokens in the yacc structure are configured to contain, in the very yacc names themselves, XML element and attribute names drawn from a TEI standard, for example TEI P5 of 2007. In such embodiments a second context free grammar [BI] is embedded in the grammar description of a context free grammar [Z]. That is, a multiset of terminal and non-terminal symbols [AD] may contain an encoded terminal or non-terminal symbol [AE], or more than one, from a multiset comprising a second context free grammar [BI]. It may, for example, comprise a multiset of XML element start-tags [BJ] or a multiset of TEI element start-tags [BK], each in encoded form. In such embodiments a conversion between grammars has been specified declaratively. Embodiments may use any encoded form for names, including none or an identity form, only as limited by the naming restrictions of a text grammar [J] used. The minimum number of symbols in these multisets of symbols will be defined by a text grammar [J] used. Embodiments are not limited in the number of additional instances of a text grammar [J] in a set of text grammars [AF], a set which comprises one or more instances of a text grammar [J] according to the appended claims and is therefore not an empty set.

FIG. 17—captioned A PUNCTUATION GRAMMAR [AS] (LEX AND YACC)—illustrates an element of a verification method [AK]—a punctuation grammar [AS]—itself an element of a text grammar [J]—according to embodiments.

A set of punctuation marks [AV] is configured within a structure called a punctuation grammar [AS] according to embodiments. One embodiment, illustrated in FIG. 17, configures a set of punctuation marks [AV] to contain ASTERISK, PLUS SIGN, and EQUALS SIGN using a structure suitable for a tool known as lex. In this embodiment the ASTERISK mark is considered significant in isolation and requiring action to be taken, for example in a verification method [AK]. In this embodiment it is also configured to take action when the two marks PLUS SIGN and EQUALS SIGN are adjacent and to consider them as a digraph representing an ASTERISK.

The use of a punctuation grammar [AS] ensures a readable text [I] is both declarative and rigorous. The elements in a rigorous set of punctuation idioms [AG] must not be ambiguous or at least ambiguity should be resolvable with further grammar rules, according to embodiments. A rigorous set of punctuation idioms [AG] used may vary according to embodiments but the requirement for lack of ambiguity remains. This requirement can be contrasted with contention cited above that ‘[Q]he “punctuational markup” used in writing is considered relatively complicated and subject to considerable stylistic variation . . . [and] is highly ambiguous.’ (Coombs et al 1997)

in this embodiment a punctuation grammar (AS) structure is further configured using a structure suitable for a tool known as yacc, whereby the lex actions are further processed as yacc tokens with the name tei_pc_ana_23ptmosPcAsteriskUnigraph or tei_pc_ana_23ptmosPcAsteriskUnigraph, either of which are configured in a punctuation grammar [AS] to be a ptmos_pc_text_asterisk token. In this embodiment a rigorous set of punctuation idioms [AG] contains one or more elements whereby diagraphs are used. In this embodiment the names of tokens in the yacc structure are configured to contain, in the very yacc name itself, XML element and attribute names drawn from the TEI standard encoded using LOW LINE escaping of those characters which are not valid in XML names.

In this embodiment, the leading part of the name ‘tei’ encodes the XML namespace. The next part of the name ‘pc’ encodes the tei element name. The XML element attributes are encoded as name-value pairs separated by double LOW LINE. Attribute values and other name parts which are not valid names in a yacc tool structure are further encoded as hexadecimal digit pairs escaped with a LOW LINE. In this embodiment the tei XML ‘ana’ attribute has a value which contains the mark NUMBER SIGN which is not a valid character in a yacc name and so is encoded as LOW LINE, DIGIT TWO, DIGIT THREE, hex 23 being the ISO 646 code for the character.

Furthermore, in this embodiment, the yacc structure does not exactly match the XML structure. The yacc structure therefore contains additional auxiliary non-terminal symbols. The names of these auxiliaries have the leading part ‘ptmos’ (tm), thus encoding another namespace, one separate from the TEI namespace.

FIG. 18—captioned A TEXT GRAMMAR [J] (PARTS VIEW)—illustrates a second alternative view of an element of a verification method [AK]—a text grammar [J]—according to embodiments.

In part of one embodiment, illustrated in FIG. 18, a text grammar [J], which is a control structure of a verification method [AK], is shown along with its sub-components: a letter grammar [AR] with sub-component a set of language marks [AU], a punctuation grammar [AS] with sub-component a set of punctuation marks [AV], and a control character grammar [AT] with sub-component a set of control characters [AX]. In this embodiment, the character SPACE is considered as a member of a set of punctuation marks [AV] and is shown as a blank to the left of the character HYPHEN MINUS, and is therefore not explicitly visible in the illustration. FIG. 18 is an abstraction and not a concrete embodiment.

FIG. 19—captioned A TEXT GRAMMAR [J] (PARTS VIEW, ALTERNATIVE)—illustrates a third alternative view of an element of a verification method [AK]—a text grammar [J]—according to embodiments.

In part of one embodiment, illustrated in FIG. 19, a text grammar [J], which is a control structure of a verification method (AKI, is shown. In this embodiment the sub-components (a letter grammar [AR] and a punctuation grammar [AS]) are merged and implemented in two separate control files: a lex source code file, here labelled with the comment lexer.l to indicate a possible filename, and a yacc grammar file, here labelled with the comment parser.y to indicate another possible filename. This embodiment is only an abstraction and further detail would be required in the lex source code and yacc grammar files before they could be configured into a concrete implementation by the utilities lex and yacc. Embodiments are not required to use the utilities lex or yace to either specify or implement a text grammar [J], other specification languages and tools may be used.

Embodiments may use a control character grammar [AT], depending on choices of tools. In come cases a control character grammar [AT] may be implicit in the tools and not be explicitly specified.

FIG. 20—captioned A TEXT GRAMMAR [J] (LEX AND YACC)—illustrates an element of a verification method [AK]—a text grammar [J]—according to embodiments.

A letter grammar [AR], a punctuation grammar [AS], and a control character grammar [AT] are configured into a combined structure, a text grammar [J], according to embodiments.

The amount of some additional information [N] able to be merged by a pointing method [AN] and an annotating method [AO] and other methods, according to embodiments, are configured by this combined structure, a text grammar [J].

One embodiment, illustrated in FIG. 20 configures a set of punctuation marks [AV] to contain LEFT SQUARE BRACKET. LEFT PARENTHESIS, and COLON using a structure suitable for a tool known as lex. In this embodiment the LEFT SQUARE BRACKET mark is considered significant in isolation and requiring action to be taken in a verification method [AK]. In this embodiment it is also configured to take action when the two marks LEFT PARENTHESIS and COLON are adjacent and to consider them as a digraph representing a left square bracket.

In this embodiment a punctuation grammar [AS], part of a text grammar [J] structure, is further configured using a structure suitable for a tool known as yacc, whereby the lex actions are further processed as yacc tokens with either the name tei_pc_ana_23ptmosPcBracketSquareLeftUnigraph or tei_pc_ana__23ptmosPcBracketSquareLeftDigraph, either of which are configured in a punctuation grammar [AS] structure to be a token pt-mos__pctext_left_square_bracket. In this embodiment a rigorous set of punctuation idioms [AG] contains one or more elements whereby diagraphs are used.

In this embodiment there is a part of the grammar structure which represents a so called text note, an element of text which is itself referenced from within the main flow of the text. The start of this text note is marked by the token ptmos_pc_text_left_square_bracket which, in this embodiment, marks the opening of the note and has the name ptmos_note_referenced_stago. The suffix ‘stago’ is a contraction of ‘start tag open’. The text note itself may consist of parts from a letter grammar [AR] with or without further parts from the punctuation a grammar [AS] and so this embodiment allows a readable text [I] to contain some additional information [N] in which some text can be identified as having the status of a note. In this embodiment a rigorous set of punctuation idioms [AG] contains one or more elements whereby text notes are identified.

FIG. 21—captioned SOME LANGUAGE CONTENT [M] (TWO HEADS SCRIPT)—illustrates an example of an input to a converting method [A]—some language content [M]—by showing it in cartoon script form—according to embodiments.

In one embodiment, FIG. 21, the language content [M] is in vocal format and has been subjected to a marking method [F], including a voice recognition sub-method. It can be assumed to have been received and understood because both parties have used the same instance of a language [AQ] and there is a response.

A set of language marks [AU] chosen in an embodiment allows a very large number of different variations of a readable text [I]. For some language content [M] and a readable text [I] to be understood, the variation in possible combinations needs constraining to a limited number. Some language content [M] and a readable text [I] are therefore subject to many semi-formal conventions and rules. However a manual method is semi-formal and error prone and rarely formally verified.

FIG. 22—captioned A VERIFICATION METHOD [AK] (PARSE)—illustrates a verification method [AK] for parsing a readable text [I] and an example of an intermediate output element of a converting method [A]—a verification result [Q]—according to embodiments.

In one embodiment, FIG. 22, a readable text [I], shown with figure label [22-1], which may be a file, is subject to a verification method [AK], shown with figure label [22-2]. A verification method [AK] uses a structure, shown with figure label [22-3], to define a text grammar [3] suitable for the tools lex and yacc. In this embodiment the verification method [AK] generates a verification exit status [AL] of the type shown here with figure label [22-4]. In this illustration, a readable text [I] does indeed conform to a text grammar [J] and a verification exit status [AL] is shown to contain the text ‘zero’ representing the digit zero, which, in embodiments using Unix (tm) customs, is an indication of success returned on exit from a process. A result generating method [AP] takes a verification exit status [AL] and produces a verification result [Q] according to embodiments.

FIG. 23—captioned A VERIFICATION RESULT [Q] (TAP OUTPUT)—illustrates a second example of an intermediate output element of a converting method [A]—a verification result [Q]—according to embodiments.

In one embodiment, shown in FIG. 23, a verification result [Q] is the text string ‘ok’ or ‘not ok’ as used in software testing with the TAP. The representation of a positive instance of a verification result [Q] in embodiments in not limited to ‘ok’ or any other text or value. In this embodiment a verification method [AK] is a command with the name ‘parse’ which returns an execution status on exit, named a verification exit status [AL]. A result generating method [AP] which acts on a verification exit status [AL] is embodied in the programming language Perl, by a TAP implementation module named ‘Test::Simple’. The command is applied to a readable text [I] contained in a file named ‘text.txt’. A verification result [Q] in this illustration contains the text string ‘ok’, as defined by TAP as a test ‘pass’, indicating how a readable text [I] should be combined with a verification result [Q] by a result registering method [AM] (not shown) to output an encapsulated text [P] (also not shown). Embodiments are not limited to using TAP or Perl or any combination of the two.

FIG. 24—captioned A RESULT REGISTERING METHOD [AM] (RENAME IN MAKE)—illustrates a sub-method—a result registering method [AM]-according to embodiments.

In an embodiment illustrated in FIG. 24, a result registering process [AM] is configured in a ‘makefile’ (a description file) of the computer utility ‘make’. A verification method [AK] is a configuration of a command named ‘parse’, invoked by ‘make’, and a result generating method [AP], which, in this embodiment, is the make utility's internal facility where ‘[b]y default, when make receives a non-zero status from the execution of a command, it shall terminate’. A result registering method [AM] in this embodiment is the computer utility program ‘mv’—move files—which moves a file containing a readable text [I] to a file name with a modified suffix thereby combining a verification result [Q] with a readable text [I] into an encapsulated text [P].

Embodiments may retain intermediate outputs, such as a readable text [I] or a verification result [Q], internally to a converting method [A] and not make them available for inspection. In such embodiments, a result registering method [AM] may be simplified to the output of a readable text [I] as an encapsulated text [P] with no need to combine a readable text [I] with a verification result [Q], the sole act of outputting anything being the mark of an allowable text [W] and an empty directory marking failure by being considered an empty set of elements, with each element being a verification pass result [Q].

FIG. 25, FIG. 26, FIG. 27, FIG. 28 and FIG. 29 all illustrate examples of a text conversion method [H] converting a post-verification text [R] element of an encapsulated text [P] to a document [L] compliant with a format [S], in this example a format [S] known as TEI XML—according to embodiments.

One or more embodiments convert some language content [M] to TEI XML, an application of SGML. One or more tools are available to further process the TEI XML into one or more other formats. In other embodiments the conversion is directly to the desired choice of a format [S]. A set of formats [T] comprises one or more elements of a format [S] according to the appended claims and is therefore not an empty set.

In one embodiment, illustrated in FIG. 25, an extract of a post-verification text [R], with figure label [25-1], being a single word ‘deny’ taken from the whole text, is subject to a method, figure label [25-2], using a lex/yacc configuration, figure label [25-3], which converts it to another format known as TET XML, figure label [25-4]. During the method, the word ‘deny’ would, in one embodiment, have been held in a yacc token with name ‘tei_w’, which is the corresponding TEI element name ‘tei:w’ LOW LINE encoded, as illustrated in FIG. 16 and as described above.

FIG. 26 illustrates a similar example and similar embodiment to FIG. 25, except here the corresponding TEI element name is tei:num. The figure labels used follow the same pattern as in FIG. 25.

FIG. 27 illustrates a similar example and similar embodiment to FIG. 25, except here the corresponding TEI element name is tei:name and it is the proper noun ‘Edward’ which is the input.

FIG. 28 illustrates a similar example and similar embodiment to FIG. 25, except here the corresponding TEI element name is tei:list with enclosed elements tei:item and tei:label.

FIG. 29 illustrates a converting method [A], in an embodiment, where a verification method [AK] determines a readable text [I] is not an allowable text [W].

In one embodiment the GNU yacc tool known as Bison is used to implement part of a converting method [A] with a modified Bison skeleton file which outputs the TEI XML as a mere side-effect of the parsing method, that is with no specific yacc actions coded, only no-operation or null actions, making a converting method declarative.

In one embodiment the SGML capability of SHORTREF is used with USEMAP to implement part of a converting method [A] as a stateful SGML parser.

In another embodiment use is made of standard XML extended to provide SHORTREF and USEMAP type facilities similar in effect to those in SGML.

Some of the above embodiments of elements of or all of a converting method [A] comprise computing methods and other embodiments comprising computing methods are possible.

In the appended claims a converting method (A) comprising computing methods is claimed independently as a computer-readable memory device [B] and also independently as a computing device [C]. Both these claim sets comprise storing a multiset of instructions [AH]. The claim set comprising a computing device [C] also comprises a processor [AI] and a reader application [AJ] elements.

### SEQUENCE LISTING

Not applicable.

The invention claimed is as follows:

1) A converting method [A]; the method comprising:
(i) converting, using a readable text [I] and a text grammar [J], between an n-tuple [K] and a document [L]; wherein the n-tuple [K] comprises some language content [M] and some additional information [N].

2) The method of claim 1 further comprising:
(i) an orthographic method [D]; the method comprising:
(a) converting between the n-tuple [K] and some pointed annotated written language [O] using the text grammar [J].

3) The method of claim 2 further comprising:
(i) a text creation method [E]; the method comprising:
(a) converting between some pointed annotated written language [O] and the readable text [I] using the text grammar [J] and a marking method [F].

4) The method of claim 3 further comprising:
(i) a text encapsulation method [G]; the method comprising:
(a) converting between the readable text [I] and an encapsulated text [P] using the text grammar [I]; wherein the encapsulated text [P] comprises: a verification result [Q] and a post-verification text [R].

5) The method of claim 4 further comprising:
(i) a text conversion method [H]; the method comprising:
(a) converting between the post-verification text [R] element of the encapsulated text [P] and the document [L].

6) The readable text [I], obtained by the method of claim 1; wherein the readable text [I] is an allowable text [W].

7) The readable text [I], obtained by the method of claim 1; wherein the readable text [I] comprises: a rigorous set of punctuation idioms [AG].

8) The document [L], obtained by the method of claim 1; wherein the readable text [I] is an allowable text [W].

9) The method of claim 1; wherein the document [L] is compliant with a format [S]; wherein the format [S] is drawn from a set of formats [T]; wherein the set of formats [T] comprises: SGML, XML, TEI, HTML, DOC, DOCX, ODX, PDF and XPS.

10) The method of claim 1; wherein the document [L] is publishable using a medium [U]; wherein the medium [U] is drawn from a set of mediums [V]; wherein the set of mediums [V] comprises: a book, a magazine, a journal, a newspaper, an article, and a web page.

11) The method of claim 1; wherein the readable text [I] consists of: a multiset of characters [X] drawn from a limited set of characters [Y].

12) The method of claim 1; wherein the text grammar [J] is one or more of: a context free grammar [Z]; or comprising: a lex description [AA], and a YACC grammar [AB].

13) The method of claim 1, wherein the text grammar [J] comprises: a set of text grammar rules [AC]; wherein the set of text grammar rules [AC] further comprises: a multiset of terminal and non-terminal symbols [AD]; wherein one or more of the multiset of terminal and non-terminal symbols [AD] is an encoded terminal or non-terminal symbol [AE]; wherein the encoded terminal or non-terminal symbol [AE] is drawn from a set of text grammars [AF]; wherein the set of text grammars [AF] comprises: SGML, XML, TEI, HTML, DOCX, ODX and XPS.

14) the method of claim 1, wherein the text grammar [J] is configured with a set of text grammar rules [AC] comprising: a rigorous set of punctuation idioms [AG].

15) the method of claim 3, wherein the readable text [I] is an allowable text [W].

16) A computer-readable memory device [B] with a multiset of instructions [AH], which is a not empty multiset, stored thereon; the multiset of instructions [AH] comprising:
(i) the performance of the method of converting, using a readable text [I] and a text grammar [J], between an n-tuple [K] and a document [L]; wherein the document [L] is compliant with a format [S]; wherein the format [S] is drawn from a set of formats [T]; wherein the set of formats [T] comprises: SGML, XML, TEI, HTML, DOC, DOCX, ODX, PDF and XPS.

17) The computer-readable memory device [B] of claim 16, wherein the text grammar [J] is one or more of: a context free grammar [Z]; or comprising: a lex description [AA], and a YACC grammar [AB].

18) The computer-readable memory device [B] of claim 16, wherein the text grammar [J] comprises: a set of text grammar rules [AC]; wherein the set of text grammar rules [AC] further comprises: a multiset of terminal and non-terminal symbols [AD]; wherein one or more of the multiset of terminal and non-terminal symbols [AD] is an encoded terminal or non-terminal symbol [AE]; wherein the encoded terminal or non-terminal symbol [AE] is drawn from a set of text grammars [AF]; wherein the set of text grammars [AF] comprises: SGML, XML, TEI, HTML, DOCX, ODX and XPS.

19) The computer-readable memory device [B] of claim 16, wherein the text grammar [J] is configured with a set of text grammar rules [AC] comprising: a rigorous set of punctuation idioms [AG].

20) A computing device [C]: the computing device [C] comprising:
(i) the computer-readable memory device [B] with a multiset of instructions [AH], which is a not empty multiset, stored thereon of claim 16; and
(ii) a processor [AI] coupled to the computer-readable memory device [B] with the multiset of instructions [AH] stored thereon of claim 16, the processor [AI] executing a reader application [AJ] with the multiset of instructions [AH] stored with the computer-readable memory device [B] with the multiset of instructions [AH] stored thereon of claim 16, wherein the reader application [AJ] is configured to perform the method of:
(a) converting, using a readable text [I] and a text grammar [J], between an n-tuple [K] and a document [L]; wherein the document [L] is compliant with a format [S] drawn from a set of formats [T]; wherein the set of formats [T] comprises: SGML, XML, TEI, HTML, DOC, DOCX, ODX, PDF and XPS.
